(19) United States
(12) Patent Application Publication
(10) Pub. No.: US 2022/0232801 A1
(43) Pub. Date: Jul. 28, 2022

(54) PROGRAMMABLE ELECTRONIC PET TRAINER

(71) Applicant: Kelley Lalumia, Henderson, NV (US)

(72) Inventor: Kelley Lalumia, Henderson, NV (US)

(21) Appl. No.: 17/341,563

(22) Filed: Jun. 8, 2021

Related U.S. Application Data
(60) Provisional application No. 63/140,370, filed on Jan. 22, 2021.

(51) Int. Cl. A01K 15/02; A01K 27/00; G06F 3/16; H04W 4/80

(52) U.S. Cl. CPC A01K 15/021; H04W 4/80; G06F 3/167; A01K 27/009

(57) ABSTRACT

A pet training system comprises one or more base stations and one or more wearable pet devices. The base station is configured to record voice commands and transmit a signal which, when received by the wearable pet device, causes the wearable pet device to generate an audible output of the command.

### RELATED APPLICATION DATA

This application claims priority to U.S. Provisional Application Ser. No. 63/140,370, filed Jan. 22, 2021, which application is incorporated herein in its entirety.

### FIELD OF THE INVENTION

The present invention relates to pet training devices.

### SUMMARY OF THE INVENTION

Aspects of the invention comprise methods and systems for training pets, such as by generating audible commands.

In one embodiment, a pet training system comprises one or more base stations and one or more wearable pet devices. The base station is configured to record one or more voice commands and transmit a signal which, when received by the wearable pet device, causes the wearable pet device to generate an audible output of the command.

In one embodiment, the base stations comprises a housing, a controller, a microphone for receiving at least one command, a memory for storing the at least one command, and a communication interface configured to transmit a signal comprising a selected command.

In one embodiment, the wearable pet device comprises a housing, a processor, a communication interface and a speaker, the wearable pet device configured to cause the speaker to audibly emit the command in response to receiving the signal from the base station.

In one embodiment, the base station stores at least a first command and a second command, wherein the commands may be voice commands which are input to the microphone and stored in the memory of the base station. The base station may include at least one input device for selecting a designated one of the at least one commands.

The system may comprise a plurality of base stations, such as located in different locations. The wearable pet device may comprise a collar, or might comprise an element which is configured to be connected to a collar, harness or the like worn by a pet.

In one embodiment, a pet owner may record one or more voice commands for their pet. The owner may then place a base station in a location such that when the pet approaches the base station, the wearable pet device emits the owner's voice command. The voice command might comprise a warning command, for example, thus warning the pet to avoid a particular area or activity. The voice command might alternatively comprise a praise command. In this embodiment, the owner's own voice is used in reinforcement to training of the pet, such as when the owner is not present.

Further objects, features and advantages of the present invention over the prior art will become apparent from the detailed description of the drawings which follows, when considered with the attached figures.

### DESCRIPTION OF THE DRAWINGS

FIG. 1 illustrates one embodiment of a system of the invention in an exemplary environment of use;

FIGS. 2A and 2B illustrate a base system in accordance with an embodiment of the invention;

FIGS. 3A and 3B illustrate a wearable pet device in accordance with an embodiment of the invention; and

FIGS. 4A and 4B are schematic illustrations of example configurations of the invention.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

Embodiments of the invention comprise methods, devices and systems for training pets.

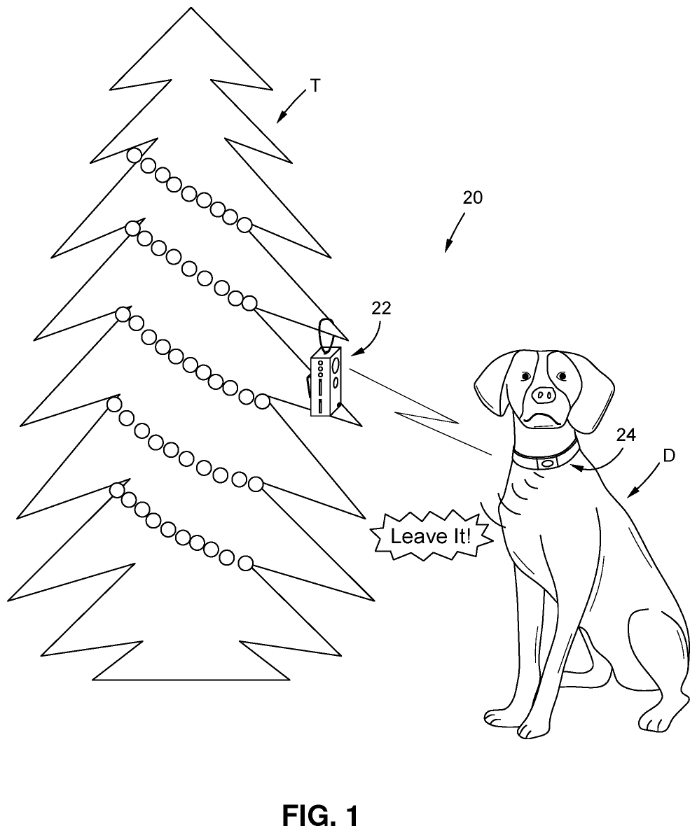

One embodiment of the invention is illustrated in FIG. 1. As illustrated, a system 20 of the invention comprises at least one base station or unit 22 and at least one wearable pet device 24.

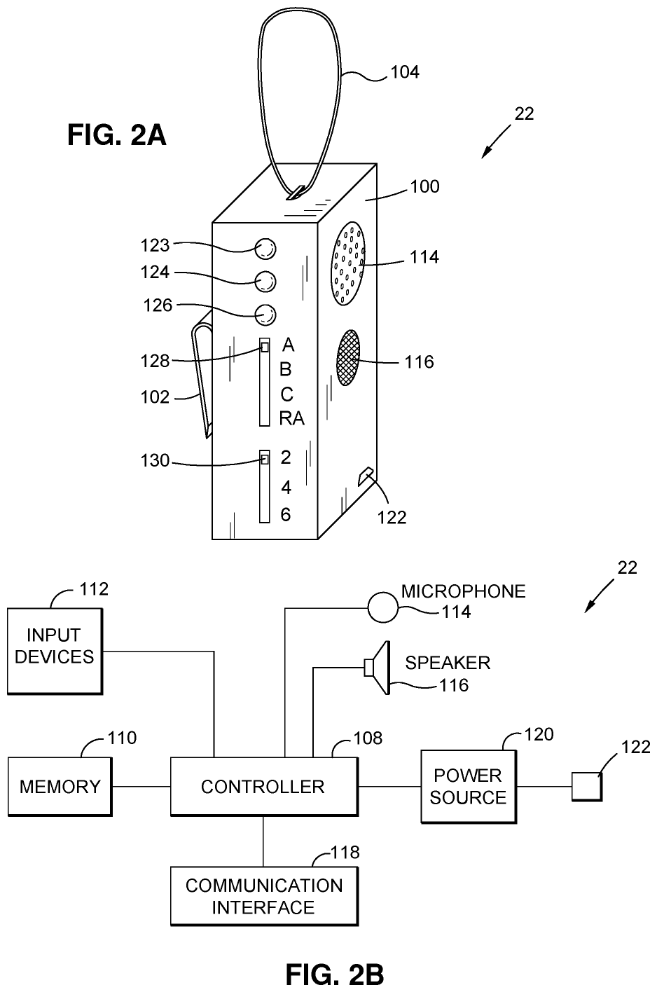

One configuration of the base station 22 will be described with reference to FIGS. 2A and 2B. In one embodiment, the base station 22 comprises a housing 100 for housing or supporting various components thereof. The housing 100 might be constructed, for example, from plastic or the like.

In one embodiment, means may be provided for supporting the base station 22 on another object. For example, a clip 102 may be attached to the housing 100 or might be formed as part of the housing. A hanger 104 (such as a hook, loop of material, etc.) might also be provided, such as extending from a top of the housing 100. Of course, other means might be provided for connecting the housing 100 to another object, such as a bracket, etc.

The housing 100 may have various shapes. While the housing 100 is illustrated as being rectangular prism shaped, but might be various shapes.

Referring to FIG. 2B, in one embodiment, the base station 22 comprises a controller 108, a memory 110 (such as for storing recorded commands), one or more input devices 112, a microphone 114, a speaker 116, and a communication interface 118 (which may comprise a transmitter/receiver and/or transceiver for transmitting/emitting and/or receiving one or signals or data). The communication interface 118 may, for example, comprise a wireless communication interface, such as a Bluetooth, radio frequency or other interface. In a preferred embodiment, the communication interface 118 comprises or supports Wi-Fi communications.

As illustrated in FIG. 2B, the base station 22 may be powered in various manners. In one embodiment, the base station 22 might be powered by a wired power source (12V power cable, etc.). However, in a preferred embodiment, the base station 22 is preferably “cordless” and is either powered by one or more batteries or other power sources 120. The batteries 120 might be rechargeable, such as to be recharged by from a power source, such as a 12V power cable, via a USB cable, etc., such as by a power port 122. The power source might also be wirelessly chargeable, such as by induction charging. The base station 22 might also include other power sources, such as a solar panel or the like. The base station 22 might have an on/off or power button (not shown) for controlling power from the power source 120.

The base station 22 may include various input devices 112. Referring to FIG. 2A, the input devices might comprise one or more buttons, touch screens, sliders or other elements. For example, the base station 22 may include a record button 123, such as for initiating a record function described below, a playback button 124, such as for initiating a playback function as described below, a volume button 126, a playback option button or slider 128, and a range selector 130. Of course, additional buttons or other input devices might be provided, or various input devise might permit multiple inputs.

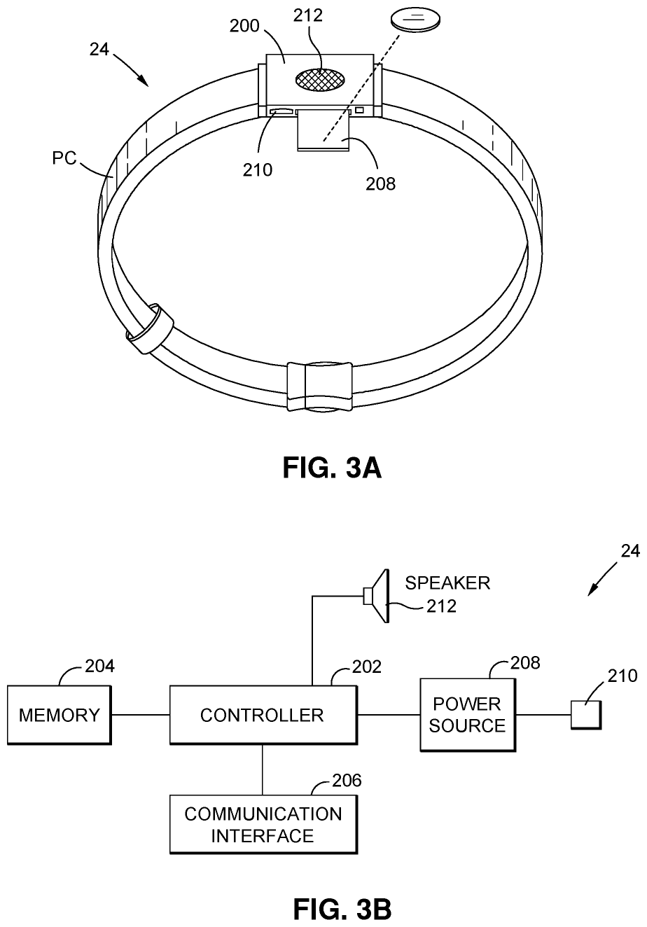

One configuration of the wearable pet device 24 is illustrated in FIG. 3A. In one embodiment, the wearable pet device 24 comprises a housing 200 that supports or contains various features of the wearable pet device.

Preferably, the wearable pet device 24 is configured to be associated with a pet, such as worn by the pet so as to travel with the pet. In one embodiment, the housing 200 may be configured to be connected to a pet or an item worn by the pet, such as being selectively connectable to a collar PC, or a harness or clothing worn by the pet. For example, the housing 200 might be configured to be connected to a collar of a pet, such as by including an opening for accepting the collar therethrough, by including a connector therefor. In other embodiments, the housing 200 might be formed integrally with such items, such as by being integrally formed with a special collar that includes the components of the pet device 24 (such as where the housing 200 is integrated into the collar and not designed to be separated therefrom). In other embodiment, wearable pet device 24 might be configured to be worn by a pet by a special element, such as a special type of neck-encircling member, etc.

Referring to FIG. 3B, the wearable pet device 24 preferably also includes a processor or controller 202, a memory 204 and a communication interface 206. The communication interface 206 may again comprise a wireless communication interface, such as a Bluetooth, radio frequency or other interface. In a preferred embodiment, the communication interface 206 is configured to communicate with the base station 22 and thus comprises or supports Wi-Fi communications.

As illustrated in FIG. 3B, the wearable pet device 24 may be powered in various manners. Since the wearable pet device 24 moves with the pet, it is preferably “cordless” and is either powered by one or more batteries or other power sources 208. The batteries might be rechargeable, such as to be recharged by from a power source, such as a 12V power cable, via a USB cable, etc., such as by a power port 210. The power source might also be wirelessly chargeable, such as by induction charging. The wearable pet device 24 might also include other power sources, such as a solar panel or the like. The wearable pet device 24 might have an on/off or power button (not shown) for controlling power from the power source 208.

In one embodiment, the wearable pet device 24 preferably also includes a speaker 212 or other audio generating device.

In one embodiment, the system 20 may include multiple base stations 22 and might include one or more wearable pet devices 24, such as worn by different pets.

Additional aspects of the system 20 will be appreciated from a description of the use/operation thereof. In one embodiment, a user programs the base stations 22, such as by recording one or more voice commands using the input devices of the base station 22, including the microphone 114. For example, the user may use the playback selector 128 to select a particular option (for example, the playback selector 128 might permit a user to select between 2 or more, such as 4, different options; those options might be referred to as Command A, Command B, Command C and Random (a random selection of the available commands)). The user might then select the record button 123 to record a voice command which is received by the microphone 114 and stored in the memory 110 (stored in association with the selected option, such as “Command A”). The user might play back the recorded command, such as by selecting the particular playback option, such as one corresponding to Command C, causing the controller 108 to play back the recorded command via the speaker 116. In this manner, the user can listen to the command to ensure it is satisfactory. In one embodiment, if the user desires, they can simply record a new command over the earlier one by repeating the steps. Further, in this manner, the base station 22 is configured to allow the user to record one or more different voice commands (or other sounds/instructions).

In one embodiment, the user may also select a range for the base station 22, such as a number of feet/meters, etc. In one embodiment, the range of the base station 22 may be varied based upon a strength of signal output by the transmitter which is associated with the communication interface 118. For example, the range selector 130 might permit the user to select from two or more ranges, such as 2 ft, 4 ft and 6 ft. In other embodiment, the base station 22 might not include a range selector.

The user may then place the base station 22 in a desired location. When there are multiple base stations 22, the base stations 22 may be placed in different locations. For example, as illustrated in FIG. 1, a user might locate the base station 22 on or near a Christmas tree T. However, this is just one example, and the user might locate the base station 22 in various locations. The user associates the wearable pet device 24 with their pet, such as a dog D, such as by placing the collar on their pet or connecting the wearable pet device 24 to the collar.

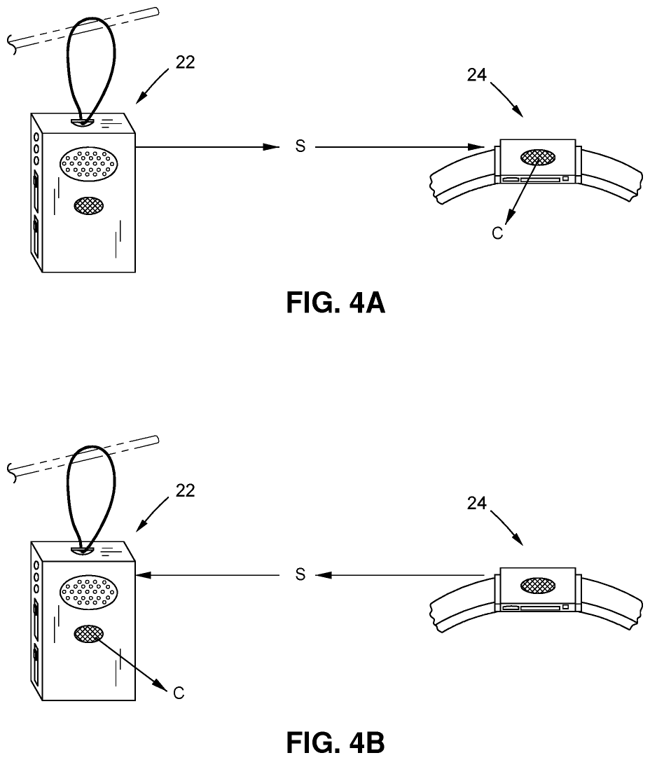

In one embodiment, as illustrated in FIG. 4A, when the pet comes into range of one of the base stations 22, the signal transmitted thereby (which includes the selected voice command) is received by the wearable pet device 24. This causes the wearable pet device 24 to generate an audible output (via the speaker 212 thereof) of the command C which is being transmitted by the base station 20

In another embodiment, as illustrated in FIG. 4B, the system 20 could be configured so that the wearable pet device 24 transmits a signal which is detected by the base station 22, thus causing the base station 22 to generate the audible output of the selected command C. In this configuration, the wearable pet device 24 might not need to include a speaker.

In yet alternate versions, both the base station 22 and wearable pet device 24 might generate the audible output. Further, in some embodiments, the base station 22 might be configured to “detect” the wearable pet device 24. For example, the base station 22 might send out a signal which triggers a response from the wearable pet device 24 when it is within a designated range, which thus triggers the base station 22 to generate the audible output of the command.

The system 20 has particular advantages in training and controlling a pet, including training a pet. For example, the system 20 may be used to train a pet to avoid certain areas or to reward them for going to certain areas, and is particularly useful in automatically training a pet when the user is not available. Relative to the example illustrated in FIG. 1, if the user desires for their pet to avoid the Christmas tree, the user places the base station 22 near the tree and may program it and/or select an option corresponding to a “Leave It” command. Then if the pet approaches the Christmas Tree, the base station 22 and/or wearable pet device 24 then generates an audible “Leave It” command, thus instructing the pet to avoid the tree. On the other hand, a base station 22 might be placed close to a dog bed and programmed with a “Good Dog” voice command, thus praising a dog that travels to its dog bed.

One advantage of the invention is that a pet owner's own voice can be recorded to provide the command(s), thus causing the pet to hear their owner's actual voice. Of course, in some variants, certain commands might be pre-recorded or pre-programmed (though such may then not be in the owner/user's own voice) or the user might record their command on another device (such as phone) and then upload the command (such as by a .wav file, etc.) to the memory of the device (such as wirelessly, via USB, etc.)

Of course, other variations of the invention are possible. For example, in one embodiment, the wearable pet device 24 might be programmed with one or more voice commands. In such an embodiment, when the wearable pet device 24 comes into range of a base station 22, the signal emitted by the base station 22 might cause the wearable pet device 24 to play the selected voice command (where the base station 22 might be provided with a selector that causes the transmitted signal to cause one particular recorded command to play—such as where “Command A” is selected at the base station 22 and the receipt of this signal from the base station causes the remote unit 26 to play “Command A” which is recorded/stored at the remote unit, or where the wearable pet device 24 includes such a selector and thus the base station 22 simply triggers the wearable pet device 24 to generate the selected option).

As indicated, the system 20 might include other features or elements. For example, the base station 22 might include a display with a touch screen, whereby various options may be presented on the display, such as by a menu, and where a user might make selections via the touch screen. For example, the features of selecting command options, range, record, playback and other inputs might all be made by the single display in this manner.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. An electronic pet training system comprising:
a base station comprising a housing, a controller, a microphone for receiving at least one command, a memory for storing said at least one command, and a communication interface configured to transmit a signal comprising one of said at least one commands; and
a wearable pet device comprising a housing, a processor, a communication interface and a speaker, said wearable pet device configured to cause said speaker to audibly emit said command in response to receiving said signal from said base station.

2. The system in accordance with claim 1 wherein said at least one command comprises at least a first command and a second command.

3. The system in accordance with claim 1 wherein said at least one command comprises a voice command input to said microphone.

4. The system in accordance with claim 1 further comprising at least one input device for selecting a designated one of said at least one commands.

5. The system in accordance with claim 1 comprising a plurality of said base stations.

6. The system in accordance with claim 1 wherein said wearable pet device is configured to be connected to a collar of a pet.

7. The system in accordance with claim 1 wherein said communication interface of said base station is configured as a Bluetooth or Wi-Fi wireless communication interface.

8. The system in accordance with claim 1 further comprising at least one input device for receiving a range selection.

9. An electronic pet training system comprising:
a base station comprising a housing, a controller and a communication interface configured to transmit a signal; and
a wearable pet device comprising a housing, a processor, a memory for storing at least one voice command, a microphone, a speaker and a communication interface, said wearable pet device configured to cause said speaker to audibly emit one of said at least one voice commands in response to receiving said signal from said base station.

10. The system in accordance with claim 9 wherein said at least one voice command comprises a voice command input to said microphone.

11. The system in accordance with claim 9 wherein said wearable pet device further comprises at least one input device for selecting a designated one of said at least one voice commands.

12. The system in accordance with claim 9 wherein said wearable pet device is configured to be connected to a pet collar.

13. The system in accordance with claim 9 further comprising at least one input device for receiving a selection of a range of said signal transmitted from said base station.

14. A method of training a pet comprising the steps of:
recording a first voice command and storing said voice command in a memory of a base station;
recording a second voice command and storing said voice command in said memory of said base station;
providing input to said base station comprising a selected command comprising said first voice command or said second voice command;
placing said base station in a desired location;
associating a wearable pet device with a pet, said wearable pet device comprising a housing, a communication interface and a speaker, said wearable pet device configured to cause said speaker to audibly emit said selected command in response to receiving a signal from said base station.

15. The method in accordance with claim 7 further comprising providing an input of a selected range of said signal from said base station, said range comprising at least a first range and a second range.
